(19) United States
(12) Patent Application Publication
(10) Pub. No.: US 2004/0123232 A1
(43) Pub. Date: Jun. 24, 2004

(54) System and method for providing a service-oriented container

(76) Inventors: Donna K. Hodges, Cumming, GA (US); Jai Menon, Alpharetta, GA (US); Marlon Osbourne, Atlanta, GA (US)

Correspondence Address: MERCHANT & GOULD PC, P.O. BOX 2903, MINNEAPOLIS, MN, 55402-0903, US

(21) Appl. No.: 10/323,501

(22) Filed: Dec. 18, 2002

(51) Int. Cl. G06F 17/21

(52) U.S. Cl. 715/513

(57) ABSTRACT

Systems and methods for providing telecommunications services are described. An embodiment of the present invention includes a construct, such as an extensible markup language (XML) construct, containing a telecommunications service model. The model is a semantic representation of the logic necessary to perform the service. A component executing within a computing environment reads the XML construct and changes its behavior based on the model contained in the construct. An interface between the computing environment and the telecommunications network provides the conduit through which services are delivered.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### FIELD OF THE INVENTION

The present invention generally relates to providing telecommunications services. The present invention more particularly relates to using virtualized resources accessing declarative logic stores to provide telecommunications services.

### BACKGROUND

Originally, programmers programmed computers by hard wiring a computer for the particular task it was to perform. Soon, multipurpose computers were created, eliminating the need to hard wire. However, programming was still a difficult task; programmers created programs an instruction at a time using hexadecimal or binary characters. The computers performed these programs sequentially. Later, assemblers were developed to simplify the job of programmers and to help eliminate errors.

The desire for more complex programming drove the development of high-level languages, which included features such as conditional control transfer. The development of conditional control transfer eventually led to the development of reusable subroutines and the creation of code libraries. Relatively recently, object-oriented languages such as C++ and Java have become the predominant languages for complex applications development. Object-oriented languages allow the programmer to create a self-contained module that can be reused across functions and applications. Theoretically, by creating an object-oriented application, the developer is eliminating any duplication of functions relating to a particular entity within an organization's computer applications. If well defined, the objects should require few changes. However, in reality, very few applications achieve this ideal because of the difficulty of fully defining the object at the design stage.

When an object requires a change, the change may affect many other objects in an application or across applications. For example, an object includes exposed methods and properties, which are accessible by other objects. Any changes to these exposed methods and properties may cause objects that utilize the changed object to fail. Therefore, changes to objects within an application should be avoided, at least to the extent possible, in order to maximize the stability of the application.

Programmers define objects using a modeling tool, such as a Unified Modeling Language (UML) compliant tool, and then build the objects using C++, Java, or other development tools. The programmers may also utilize additional tools to configure the components to function within an execution environment, such as Java2 Enterprise Edition (J2EE). When an application changes, changes to the execution environment may also be required in order to implement the changes to the individual objects. At the very least, the new version of the object will need to be distributed and reregistered.

The process of making changes becomes more complex as additional layers are added to the environment in which the components are utilized. For example, in order to provide a service, telecommunications providers, regional bell operating companies (RBOC), competitive local exchange carriers (CLEC), and interexchange carriers (IXC) work together as a loosely coupled virtual provider. The providers accomplish this coupling through the use of common protocols, such as SS7 and Internet protocol (IP). As converged networks become more common, the opportunity to share network resources, such as computing resources, increases. However, as participants are added to the virtual provider network, the complexity of sharing resources increases. This added complexity affects not only the process of making changes but also the management, metering, and billing for services provided by the network.

A method of simplifying the process of making changes to objects used for providing telecommunications services is needed. A method for providing management, metering, and billing in a complex, virtualized computing environment is also needed.

### SUMMARY

The present invention provides systems and methods for providing telecommunications services. An embodiment of the present invention includes an extensible markup language (XML) construct containing a telecommunications service model. The model is a representation of the logic necessary to perform the service. A component, also referred to as a service-oriented container, executing within a computing environment reads the XML construct and changes its behavior based on the model contained in the construct. An interface between the computing environment and the telecommunications network provides the conduit through which services are delivered.

The component may be, for example, an Enterprise Java Bean (EJB) or an ActiveX component. The component may provide a variety of services, such as a two-party call or a voice-mail service. The component is an object operating within an execution environment. The execution environment operates within a computing environment, such as an applications server, a cluster, or a grid. The execution environment may be an Open Grid Services Architecture, Microsoft .NET, Java 2 Enterprise Edition (J2EE) and Common Object Model+(COM+). In order to provide the service, the component executes commands according to a communications standard. For example, in one embodiment, the component executes session initiation protocol (SIP) commands.

One embodiment of a method for developing a telecommunications service according to the present invention includes creating a model of the service, converting the model into an extensible markup language (XML) construct, and creating a component or service-oriented container for providing the service that executes the service model by interpreting the XML construct. When the system receives a request to provide the service, the component retrieves the model of the service from the XML construct and provides the service based on the model.

Embodiments of the present invention offers numerous advantages over conventional systems. In providing service in such a manner, telecommunications providers, including regional bell operating companies (RBOC), competitive local exchange carriers (CLEC), and inter-exchange carriers work together as a loosely-coupled virtual provider. The providers accomplish this coupling through the use of common protocols, such as SS7 and Internet protocols. Changes to services offered by providers conventionally require extensive programming changes. Also, a change must be made simultaneously by all providers because of the way their networks are coupled. In contrast, in an embodiment of the present invention, only the construct used by the virtual provider is simply modified in order to change the service.

In addition, in an embodiment utilizing a grid computing architecture, the virtual provider is more readily able to provision the service because the Grid architecture was designed from the outset to allow the loose coupling between computer systems in order to create a virtual organization. Implementing a grid within the organization helps to alleviate problems of instituting incompatible services by requiring stricter controls. An embodiment of the present invention implements billing, monitoring, and metering processes within in a grid to achieve and maintain security, scalability, robustness, and reliability of the various services and the network in general.

Further details and advantages of the present invention are set forth below.

### BRIEF DESCRIPTION OF THE FIGURES

These and other features, aspects, and advantages of the present invention are better understood when the following Detailed Description is read with reference to the accompanying drawings, wherein:

FIG. 1A illustrates an exemplary environment for implementation of one embodiment of the present invention;

FIG. 1B illustrates another exemplary environment for implementation of one embodiment of the present invention;

FIG. 2 is a block diagram, illustrating the software application layers present in one embodiment of the present invention;

FIG. 3 is a flowchart, illustrating the process of creating a profile in an embodiment of the present invention;

FIG. 4 is a flow chart, illustrating the process of using a service in an embodiment of the present invention;

FIG. 5 is a flow chart, illustrating the process of initiating a two-party voice over Internet protocol (VoIP) call in an embodiment of the present invention.

### DETAILED DESCRIPTION

Embodiments of the present invention provide systems and methods for providing telecommunications services. One embodiment of the present invention includes an extensible markup language (XML) construct containing a telecommunications service model. The model is a representation of the logic necessary to perform the service. A component executing within a computing environment reads the XML construct and changes its behavior based on the model contained in the construct. An interface between the computing environment and the telecommunications network provides the conduit through which services are delivered.

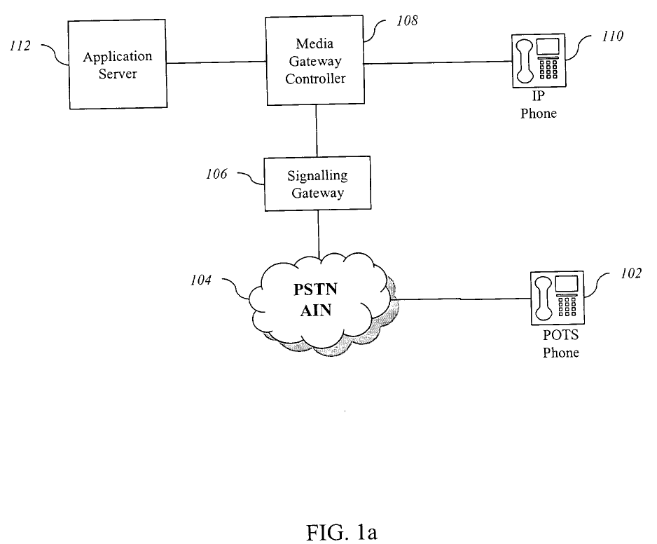

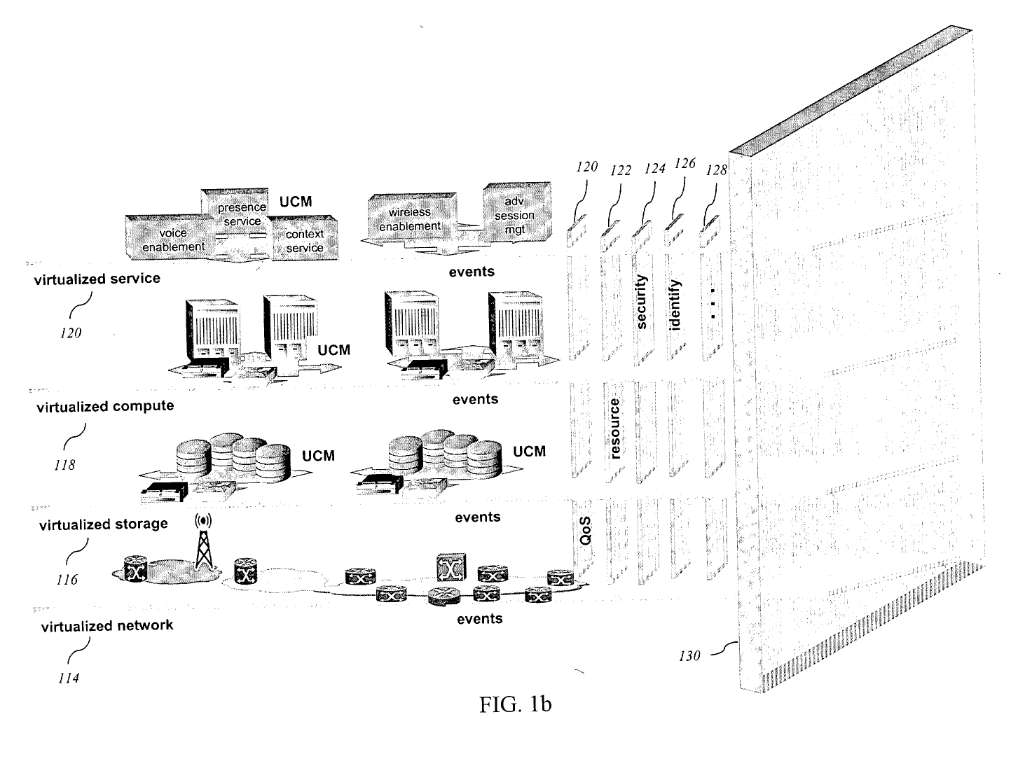

Referring now to the drawings in which like numerals indicate like elements throughout the several figures, FIG. 1A illustrates an exemplary environment for implementation of one embodiment of the present invention. In the embodiment shown, a subscriber uses a plain old telephone system (POTS) phone 102 to access telecommunications services. The POTS phone 102 is in communication with a public switched telephone network (PSTN) 104. The PSTN 104 includes various elements for handling communications, including advanced intelligent networking (AIN) components. PSTN 104 may also utilize non-AIN components to deliver services.

For example, in the embodiment shown, the PSTN 104 is in communication with a signaling gateway 106. The signaling gateway 106 provides a gateway for signaling between a packet-based telecommunications network and a circuit based network, such as a signaling system 7 (SS7) network. The signaling gateway 106 encapsulates and transports traffic from the PSTN 104 to elements in the packet-based network, such as a media gateway controller (MGC) 108. The signaling gateway 106 may utilize Signaling Transport (SIGTRAN). SIGTRAN is designed for transporting signaling traffic, such as integrated services digital network (ISDN) and SS7 over an IP network. SIGTRAN comprises the Stream Control Transmission Protocol (SCTP) and the User Adaptation Layers (UA) for each signalling protocol transported over IP. Both signaling gatewaly 106 and MGC 108 utilize SIGTRAN for voice over packet (VoP) applications.

The MGC 108 provides call logic and call control signaling for the packet-based network elements. The MGC 108 also transmits bearer messages, i.e., voice traffic, between Internet protocol (IP) phone 110 and signaling gateway 106. The MGC 108 also interfaces with administrative systems to perform call routing, authentication, and accounting. In addition, the MGC 110 may interact with an application server 112 to provide services to a call. The MGC 110 supports a variety of protocols and APIs, including H.248, media gateway control protocol (MGCP), session intitiation protocol (SIP), transmission capability application part (TCAP), and Java application interface network (JAIN).

The application server 112 provides service logic and execution for applications and services. The application server 112 may cause the MGC 108 to terminate or reroute calls, or to control external resources, such as signaling gateway 106. In addition, the application server 112 may interface with other application servers (not shown) when necessary. The application server 112 supports various user interfaces, including Web interfaces.

It is important to note that the elements in FIG. 1A are merely exemplary. The media gateway controller, application server, and signaling gateway are combinations of computer hardware and software. In the embodiment shown, the various elements are computers, which are capable of communication with one another using standard or proprietary communication protocols and application programming interfaces (APIs). However, in other embodiments, a single computer may perform the functionality performed by the various elements. Alternatively, a cluster of computers or a grid computing environment may perform the necessary functionality. The actual implementation depends on the requirements of the telecommunications service provider implementing the system.

FIG. 1B is a block diagram, illustrating another exemplary environment for implementation of an embodiment of the present invention. In the embodiment shown in FIG. 1B, the provider or providers implement a grid computing environment to provide services. In the environment shown in FIG. 1B, the various elements of the virtual service provider are depicted as planes. Intersecting planes depicts the methods performed by the service provider in managing the environment.

The first plane in FIG. 1B is the virtualized network plane 114. The virtualized network plane depicts the physical elements of the network, including switches, broadcast towers, and the like. The virtualized network plane 114 also includes events. Particular events occur in each segment of a telecommunications provider. For example, in the virtualized network 114 segment of the network, calls are initiated and terminated.

The second plane in FIG. 1B depicts virtualized storage 116. Virtualized storage 116 includes all of the various magnetic, optical, or other storage devices available to elements of an embodiment of the present invention. The virtualized computer plane 118 includes various platforms for executing application code, such as the application for virtualized services 120 provided by an embodiment of the present invention.

The embodiment shown in FIG. 1B provides multiple challenges to telecommunications providers. The providers manage the network just as they do conventional networks. The planes shown that intersect planes 114-120 illustrate the management and control tasks performed by the providers. First, as with conventional networks, the providers ensure a certain level of quality of service 120. Ensuring quality of service requires management of the network 114, storage 116, compute 118, and service 120 planes. It also requires evaluating the data content of various types of communications, and performing semantic resolution of the particular XML construct to determine the requirements of the specific service provided to the user.

The providers may also perform resource management 122 to ensure an efficient utilization of resources. Brokering the resources requires discovering which resources are available to the virtual provider, matching those resources to a particular task, and aggregating resources as necessary. In addition, once service provision is initiated, the provider monitors the communication to ensure quality of service, or at least a lack of failures, and meter the communication so that billing may be done.

The provider may perform additional tasks as well, including managing and maintaining security 124, verifying the identify of participants 128, setting policies, managing the trading of various resources between providers, managing digital rights management, and brokering services.

Brokering services is a complex task for a virtual provider in an embodiment of the present invention. As with resource brokering, the provider must perform discovery of available services, match the services with the request, and aggregate multiple services when necessary. In addition, the provider may perform real-time negotiation, such as when the resources available to the service are less than requested by a user. Also, the provider may perform reservation, monitoring, and metering functions for the various services. Also, since the services will change over time, the provider must perform life-cycle management in order to continue to service the provider's customers.

The elements shown in FIG. 1A and 1B, are often referred to as a softswitch environment. When elements of the embodiment shown receive a request to make a call, rather than relying on mechanical or electrical switch, software determines how the call is to be processed and completed. Traditionally, software has executed linearly, executing a program step-by-step. However, more recently, software has evolved into an object-oriented paradigm. Object-oriented programming (OOP) requires the description and manipulation of objects. An object has state and behaviors. State is maintained through the use of properties, also referred to as variables. Behaviors are implemented through an object's methods. Objects are modular; the properties and methods change independently of other objects. Objects are generally written to be reusable, however, they must often be modified. Modification of an object can have a ripple effect, requiring changes to all of the objects that call or are called by the object to be changed.

Changes to a process for providing a telecommunications service requires a corresponding change to an object that is written to provide the service. In an embodiment of the present invention, the object itself need not be modified, because the logic necessary to implement the service is contained within an HTML construct.

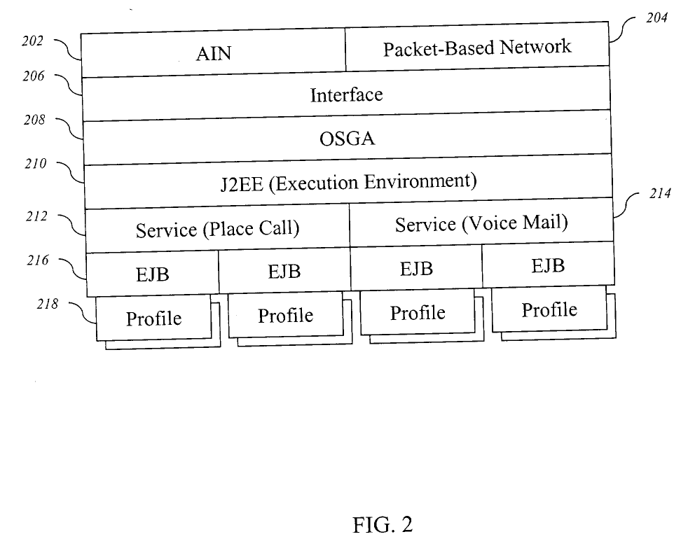

To understand the architecture present in a software application, particularly and object-oriented application, it is often helpful to examine the various layers and interaction between the layers of software present in the application. FIG. 2 illustrates the software application layers present in one embodiment of the present invention. [Should the service layer in the diagram appear as it is or between the Interface and OSGA layers?] In the embodiment shown, an AIN 202 or packet-based network 204 initiates request for service. An interface 206, such as MGC (108) processes these requests. The interface 206 processes these requests by utilizing services.

In one embodiment of the present invention, an open grid services architecture (OSGA) 208 virtualizes these services. The location, capability, and attributes of the computational, storage, network, application, database resources and the like are hidden from the interface 206, removing complexity and simultaneously adding flexibility. In the OGSA environment, interfaces support the creation of service instances across a grid. These interfaces may include, for example, a Factory, a Registry, a GridService, and a HandleMap interface. These basic interfaces enable the implementation of various underlying physical structures. Other embodiments utilize a Microsoft .NET environment to support distributed services.

In the embodiment shown, the computational resources execute within a simple hosting environment, Java2 Enterprise Edition (J2EE) 210. In other embodiments, the hosting environment may include a Microsoft .NET system, a Linux cluster, a mainframe, or other computing system. The interfaces necessary for such an environment typically include multiple factories, which are recorded in a registry. The registry allows the methods and properties of the factories to be determined. When one of the factories receives a request to create an instance of the factory, the factory invokes J2EE-specific commands to create the new instance.

For example, in FIG. 2, two factories correspond to two services, place call 212 and voice mail 214. The place call service 212 provides the properties and methods necessary to instantiate a two-party call. The voice mail service 214 provides the properties and methods necessary to provide a voice mail service for a subscriber. Within the J2EE environment 210, each of these services utilizes one or more Enterprise Java Bean (EJB) components 216.

In a conventional system, the EJB components 216 comprise the logic necessary to perform particular tasks. In other words, all of the logic is encoded in the programming steps stored in the component. In contrast, in an embodiment of the present invention, much of the logic for performing specific tasks is declaratively set out in profiles 218. The EJB components 216 read the profiles to determine the steps that are executed in order to provide the service. The profiles may exist in many forms. For example, in one embodiment, the profiles comprise XML files that the EJB components 216 are able to read.

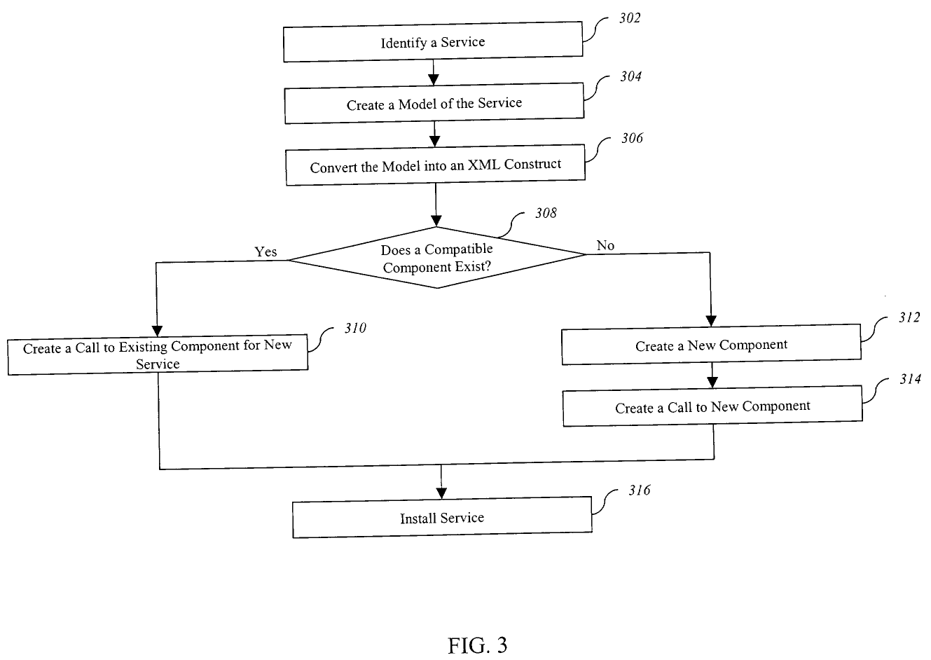

The processes of creating and using the environment set out in FIG. 2 is described in more detail utilizing FIGS. 3, 4, and 5. FIG. 3 is a flowchart, illustrating the process of creating a profile (218) in an embodiment of the present invention. In the method shown, the service provider first identifies a service, such as two-party calling 302. The service provider then creates a model of the service 304. The model includes all of the steps necessary to perform a particular process. For example, to complete a two-party call in a voice over Internet protocol (VoIP) system, the provider may refer to the Session Initiation Protocol (SIP) standard (RFC 2543, www.faqs.org/frds/rfc2543.html). Using the SIP standard, the provider determines that the first step in the process is to issue an invitation using the “INVITE” command. In addition, the provider determines that additional information must be included in the invitation. The provider includes this information in the model.

The provider next converts the model into an XML construct 306. The XML construct provides a structure for listing the steps necessary to carry out a particular function. In other words, the XML construct includes the process set out in a declarative form. The steps of the process may be set out in a textual format, include actual commands from a communications protocol, or may include codes for executing corresponding commands. Once the provider converts the model to an XML construct, the provider attempts to identify an existing component that is compatible with the newly-defined service process 308. For example, in the example of creating SIP-compatible process, the provider may have previously created a component capable of reading and interpreting SIP commands from an XML construct and issuing the necessary commands. If the provider identifies a compatible component, the provider creates a new factory in the OSGA environment (208) that calls the existing component, which reads the new profile (218) 310. For example, the component may simply require that the name and location of the XML profile be provided in order to create a new service. In such a case, the new service is simply a new virtual service created by registering the existing service with a new parameter value specified.

If a compatible component does not exist, the provider creates a new component 312. In the environment shown in FIG. 2, creating a new component comprises writing a new EJB component (216), registering the component within the J2EE execution environment (210), and registering a new factory in the OSGA environment (208), which corresponds to the EJB component (216).

Once the new or existing component and service have been defined, the service provider installs the service and related components 316. Installing the service comprises adding an element to the interface (206) and to the AIN (202) or packet-based network (204) that utilizes the service. Installing the service may also comprise physically installing a component on an applications server (112) and registering the component in both the J2EE (210) environment and the OSGA environment (208).

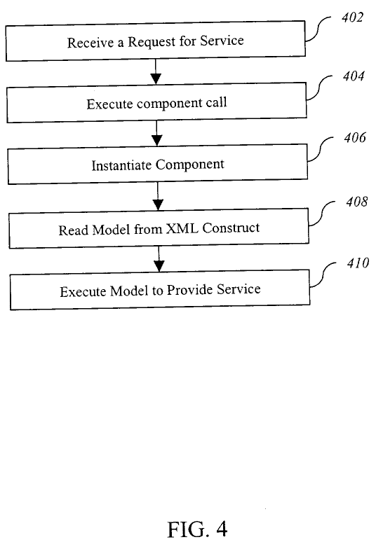

Once the service is installed, the service can be used by an element within the AIN (202) or the packet-based network (204). FIG. 4 is a flow chart, illustrating the process of accessing or using a service in an embodiment of the present invention. The provider first receives a request for service 402, such as for initiating a two-party call or for accessing a voice mail service. In response to the request, the OSGA (208) checks the OSGA registry to determine which factory to utilize. The OSGA (208) then creates a grid service factory instance 404. A factory describes a particular grid service, including its properties or attributes and methods. Each individual instance of a grid factory has property values and attributes unique to the instance. When the grid service factory instance is created, the factory utilizes capabilities of the J2EE environment (218) to create an instance of an EJB component (216) 406. The J2EE environment (218) determines where the component (216) resides on a physical storage medium and how the component (216) is to be instantiated within the appropriate operating system and execution environment.

The newly created instance of the EJB component (216) opens the XML construct and reads the steps in the model for the process of providing the requested service. These steps have been previously identified and declaratively set out using the construct 408. The EJB component (216) executes each step in the modeled process. Upon execution of a particular step, the EJB component performs the necessary processing and passes information, including success or failure indicators, up through the various layers shown in FIG. 2 in order to provide the interface, and ultimately the user, status and other information for the requested service 410. For example, if a called line is busy, the EJB component (216) provides this information to the caller via the various layers.

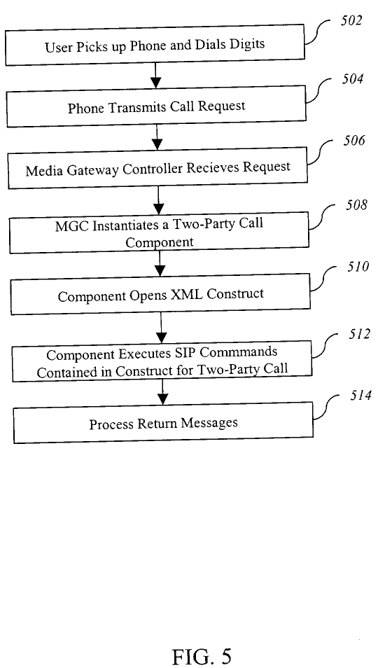

FIG. 5 is a flow chart, illustrating the process of initiating a two-party voice over Internet protocol (VoIP) call in an embodiment of the present invention. In the process shown, the user picks up a phone, such as IP phone (110), and dials the digits of the party to be called 502. The IP phone (110) transmits a call request to the media gateway controller (MGC) (108) 504. The MGC (108) receives the request, which includes attributes of the call, such as the dialing number and the dialed number 506. The MGC (108) instantiates a two-party call component within the OSGA (208) 508. The OSGA (208) utilizes the J2EE environment (210) to instantiate the EJB two-party call component, which executes on the application server (112). Although the application server in FIG. 1A is depicted as a single element, the application server may be a single computer, a cluster or a grid.

The component opens an XML construct to read the model for the two-party call 510. The two-party call component reads the process steps from the construct for initiating the two-party call 512. In the example shown, the construct comprises a series of session initiation protocol (SIP) commands necessary for completing a two-party call. As the component executes each SIP command, a status message of some type is returned to the component. The component relays these messages to the interface (206), which relays the information to the user or to the peripheral that the user is using. 514. For example, if the component issues a call connect command, and the line is busy, a busy signal is returned to the user.

The foregoing description of the preferred embodiments of the invention has been presented only for the purpose of illustration and description and is not intended to be exhaustive or to limit the invention to the precise forms disclosed. Numerous modifications and adaptations thereof will be apparent to those skilled in the art without departing from the spirit and scope of the present invention.

That which is claimed:

1. A method for developing telecommunications services comprising:
creating a model of a telecommunications service;
converting said model into an extensible markup language (XML) construct; and
creating a component for providing said telecommunications service, wherein said component executes said model by interpreting said XML construct.

2. The method of claim 1, wherein said component comprises a component selected from the group consisting of an enterprise java bean and an ActiveX component.

3. The method of claim 1, wherein said telecommunications service comprises a two-party call.

4. The method of claim 1, wherein said telecommunications service comprises a voice mail service.

5. A method for providing telecommunications services comprising:
receiving a request to provide a telecommunications service;
retrieving a model of said telecommunications service from an extensible markup language (XML) construct; and
providing said service based on said model.

6. The method of claim 5, wherein providing said service comprises executing a component in an execution environment, wherein a behavior of said component varies based on a profile stored in said XML construct.

7. The method of claim 6, wherein said execution environment comprises an environment selected from the group consisting of Open Grid Services Architecture, Microsoft .NET, Java 2 Enterprise Edition (J2EE) and Common Object Model+(COM+).

8. The method of claim 6, wherein said behavior comprises execution of a plurality of session initiation protocol (SIP) commands.

9. A system for providing telecommunications services comprising
an extensible markup language (XML) construct, comprising a model for performing a telecommunications service;
a component capable of reading said XML construct and changing a behavior based on the contents of said XML construct;
a computing environment for executing said component;
an interface in communication with said computing environment; and
a telecommunications network in communication with said interface.

10. The system of claim 9, wherein said component comprises a component selected from the group consisting of an enterprise java bean and an ActiveX component.

11. The system of claim 9, wherein said telecommunications service comprises a two-party call.

12. The system of claim 9, wherein said telecommunications service comprises a voice mail service.

13. The system of claim 9, wherein said computing environment comprises an applications server.

14. The system of claim 9, wherein said computing environment comprises a cluster.

15. The system of claim 9, wherein said computing environment comprises a grid.

16. The system of claim 9, wherein said computing environment comprises an execution environment selected from the group consisting of Open Grid Services Architecture, Microsoft .NET, Java 2 Enterprise Edition (J2EE) and Common Object Model+(COM+).

17. The system of claim 9, wherein said behavior comprises execution of a plurality of session initiation protocol (SIP) commands.
